(19) United States
(12) Patent Application Publication
(10) Pub. No.: US 2025/0105269 A1
(43) Pub. Date: Mar. 27, 2025

(54) LITHIUM ALLOY ANODE

(71) Applicant: GM GLOBAL TECHNOLOGY OPERATIONS LLC, Detroit, MI (US)

(72) Inventors: Diptak Bhattacharya, Royal Oak, MI (US); Sayed Youssef Sayed Nagy, Troy, MI (US); Caleb Reese, Ferndale, MI (US); Yoojin Kim, Shelby Township, MI (US); Shaomao Xu, Sterling Heights, MI (US); Hassan Ghassemi-Armaki, Northville, MI (US)

(73) Assignee: GM GLOBAL TECHNOLOGY OPERATIONS LLC, Detroit, MI (US)

(21) Appl. No.: 18/473,799

(22) Filed: Sep. 25, 2023

(51) Int. Cl. H01M 4/40; C22C 1/02; C22C 24/00; H01M 4/02; H01M 4/04; H01M 4/134; H01M 4/1395; H01M 4/38; H01M 4/42; H01M 4/74; H01M 10/052

(52) U.S. Cl. CPC H01M 4/405; C22C 1/02; C22C 24/00; H01M 4/0404; H01M 4/134; H01M 4/1395; H01M 4/387; H01M 4/42; H01M 4/74; H01M 10/052; H01M 2004/021; H01M 2004/027

(57) ABSTRACT

Methods for fabricating an anode, methods for fabricating a battery, and lithium batteries are disclosed. A method for fabricating an anode includes forming a melt comprising lithium and a surface tension reduction agent, wherein the surface tension reduction agent is selected from the group consisting of silver, tin, gallium, indium, zinc, and combinations thereof; and contacting an anode current collector with the melt, wherein a layer of the melt wets onto the anode current collector to form the anode as a lithium alloy.

### INTRODUCTION

The technical field generally relates to lithium anodes and methods for fabricating lithium anodes on current collectors for forming lithium batteries.

High-energy density, electrochemical cells, such as lithium-ion batteries can be used in a variety of consumer products and vehicles, such as Hybrid Electric Vehicles (HEVs) and Electric Vehicles (EVs). Typical lithium-ion batteries include a first electrode, a second electrode, an electrolyte material, and a separator. One electrode serves as a positive electrode or cathode (on discharge) and another serves as a negative electrode or anode (on discharge). A stack of battery cells may be electrically connected to increase overall output. Conventional rechargeable lithium-ion batteries operate by reversibly passing lithium-ions back and forth between the negative electrode and the positive electrode. A separator and an electrolyte are disposed between the negative and positive electrodes. The electrolyte is suitable for conducting lithium-ions and may be in solid (e.g., solid state diffusion) or liquid form. Lithium-ions move from a cathode (positive electrode) to an anode (negative electrode) during charging of the battery, and in the opposite direction when discharging the battery.

The negative electrode (anode) may be made of metallic lithium (often referred to as a lithium metal anode (LMA)), so that the electrochemical cell is considered a lithium metal battery or cell. Metallic lithium for use in the negative electrode (anode) of a rechargeable battery has various potential advantages, including having the highest theoretical capacity and lowest electrochemical potential. Thus, batteries incorporating lithium metal anodes can have a higher energy density that can potentially double storage capacity, so that the battery may be half the size, but still last the same amount of time as other lithium ion batteries. Lithium metal batteries are thus one of the most promising candidates for high energy storage systems.

However, lithium metal batteries can potentially exhibit unreliable or diminished performance leading to the potential for diminished electrochemical cell lifetime. For example, a potential source of diminished performance in lithium metal batteries can be related to weak long-term adhesion of lithium metal to the metal current collector, which can result in undesirable increases in resistance and impedance over time when the lithium-based negative electrode is used in an electrochemical cell. Accordingly, it would be desirable to develop reliable, high-performance lithium-containing negative electrode materials for use in high energy electrochemical cells that can minimize diminished performance over time (e.g., to minimize increases in resistance/impedance and capacity fade for long-term use). Also, it would be desirable to provide improved methods for fabricating lithium-based anodes and lithium batteries using lithium-based anodes.

### SUMMARY

In one embodiment, a method for fabricating an anode includes forming a melt comprising lithium and a surface tension reduction agent, wherein the surface tension reduction agent is selected from the group consisting of silver, tin, gallium, indium, zinc, and combinations thereof; and contacting an anode current collector with the melt, wherein a layer of the melt wets onto the anode current collector to form the anode as a lithium alloy.

In certain embodiments of the method, the layer of the melt has a thickness of from 30 to 60 micrometers (μm).

In certain embodiments of the method, the anode current collector is formed as a mesh of ribbons, and the layer of the melt surrounds the ribbons.

In certain embodiments of the method, the anode current collector is copper or stainless steel.

In certain embodiments of the method, forming the melt includes melting solid lithium to form molten lithium; and adding the surface tension reduction agent to the molten lithium.

In certain embodiments of the method, the forming the melt includes melting solid lithium to form molten lithium having a round surface; and adding the surface tension reduction agent to the molten lithium to form the melt.

In certain embodiments of the method, forming the melt includes melting solid lithium to form molten lithium having a round surface; and adding the surface tension reduction agent to the molten lithium until the melt has a flat surface.

In certain embodiments of the method, the surface tension reduction agent is silver, and the lithium alloy is a lithium-silver alloy including less than 1 atomic % silver.

In certain embodiments of the method, the surface tension reduction agent is tin, and the lithium alloy is a lithium-tin alloy including less than 10 atomic % tin.

In certain embodiments of the method, the surface tension reduction agent is gallium, and the lithium alloy is a lithium-gallium alloy including less than 20 atomic % gallium.

In certain embodiments of the method, the surface tension reduction agent is indium, and the lithium alloy is a lithium-indium alloy including less than 20 atomic % indium.

In certain embodiments of the method, the surface tension reduction agent is zinc, and the lithium alloy is a lithium-zinc alloy including less than 30 atomic % zinc.

In an embodiment, a method for fabricating a battery includes wetting an anode current collector with a melt to form an anode as a lithium alloy on the anode current collector, wherein the melt includes lithium and a surface tension reduction agent, and wherein the surface tension reduction agent is selected from the group consisting of silver, tin, gallium, indium, zinc, and combinations thereof; separating the anode from a cathode with a separator; and contacting the anode and the cathode with an electrolyte.

In certain embodiments, the method further includes forming the melt by melting solid lithium to form molten lithium and adding the surface tension reduction agent to the molten lithium.

In certain embodiments, the method further includes forming the melt by melting solid lithium to form molten lithium having a round surface and adding the surface tension reduction agent to the molten lithium until the melt has a flat surface.

In an embodiment, a lithium battery includes an anode current collector formed from a collector material; an anode active material directly contacting the collector material, wherein the anode active material is a lithium alloy of lithium and silver, tin, gallium, and/or indium; a cathode active material; a separator between the anode active material and the cathode active material; and an electrolyte in contact with the anode active material and the cathode active material.

In certain embodiments of the battery, the lithium alloy is a lithium-silver alloy including less than 1 atomic % silver.

In certain embodiments of the battery, the lithium alloy is a lithium-tin alloy including less than 10 atomic % tin.

In certain embodiments of the battery, the lithium alloy is a lithium-gallium alloy including less than 20 atomic % gallium.

In certain embodiments of the battery, the lithium alloy is a lithium-zinc alloy comprising less than 30 atomic % zinc.

In certain embodiments of the battery, the collector material is copper or stainless steel.

In certain embodiments of the battery, the anode current collector is a mesh formed by ribbons of the collector material, and the mesh is surrounded by the anode active material.

### DESCRIPTION OF THE DRAWINGS

The present disclosure will hereinafter be described in conjunction with the following drawing figures, wherein like numerals denote like elements, and wherein:

FIG. 1 is a schematic view of successive fabrication stages of a method for fabricating a lithium alloy metal anode according to exemplary embodiments of the present disclosure;

FIG. 2 is a schematic view of a battery formed from a lithium alloy metal anode according to embodiments of the present disclosure;

FIG. 3 is a perspective view of a mesh current collector for use in certain embodiments of the present disclosure;

FIG. 4 is a tomographic cross-sectional view of the lithium alloy anode formed around a wire or ribbon of a mesh current collector according to embodiments of the present disclosure;

FIG. 5 is a schematic illustrating the contact angle, solid surface tension, liquid surface tension, and interfacial tension of solid/liquid; and

FIG. 6 is a free energy composition diagram for binary Li—X molten liquids as a function of the concentration of the alloying element X, according to embodiments of the present disclosure.

### DETAILED DESCRIPTION

The following detailed description is merely exemplary in nature and is not intended to limit the application and uses of embodiments herein. Furthermore, there is no intention to be bound by any expressed or implied theory presented in the preceding introduction, summary or the following detailed description. As used herein, the term module refers to any hardware, software, firmware, electronic control unit or component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of automated driving systems including cruise control systems, automated driver assistance systems and autonomous driving systems, and that the vehicle system described herein is merely one example embodiment of the present disclosure.

Finally, for the sake of brevity, conventional techniques and components related to vehicle mechanical parts and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment. It should also be understood that the figures are merely illustrative and may not be drawn to scale.

Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

An exemplary lithium battery, method for fabricating an anode, and method for fabricating a battery are provided to simplify the fabrication process and reduce cost.

In certain embodiments, a lithium alloyed bath is provided with reduced surface tension, as compared to a lithium bath, to allow spontaneous wetting of lithium onto a currently collector without the need of any lithiophilic coating or surface treatment on the current collector. Because no lithiophilic coating or surface treatment process is needed, the process is simplified, process time is reduced, and cost is reduced.

Further, the use of the lithium alloyed bath allow a current collector to be immersed in the molten bath for wetting both or all sides of the current collector. The current collector may be in the form of a foil with two sides, or a three-dimensional mesh of wires or ribbons that may be surrounded by the molten bath. Thus, the lithium alloy may be inserted into voids of the mesh current collector without the need for a lithiophilic pre-coating or surface pre-treatment process. Further, for mesh current collectors, the reduced surface tension of the molten alloyed bath prevents excessive distortion of the mesh when inserted into or pulled from the molten alloyed bath.

In certain embodiments, the surface tension and wettability of the alloyed bath onto the current collector may be tuned by controlling the addition of a surface tension reduction agent (or alloying element) to the molten lithium. The surface tension reduction agent may be selected from silver, tin, gallium, indium, zinc, and combinations thereof. The surface tension reduction agent may be added to the bath until the surface shape of the bath changes. For example, a molten lithium bath has a convex meniscus shape. The meniscus shape may be used as an indicator for determining an appropriate amount of surface tension reduction agent addition. Certain embodiments determine that an appropriate amount of surface tension reduction agent has been added when the meniscus is no longer convex, i.e., when the upper surface of the bath is planar or flat.

Further, in certain embodiments, the thickness of the lithium alloy anode material formed on or around the current collector may be tuned by controlling the addition of a surface tension reduction agent (or alloying element) to the molten lithium. For example, the thickness of the lithium alloy anode material formed on or around the current collector may be from 30 to 60 micrometers (μm).

In certain embodiments, silver is added to the molten lithium bath such that the bath has a total silver content of less than 1 atomic percent. In certain embodiments, tin is added to the molten lithium bath such that the bath has a total tin content of less than 10 atomic percent. In certain embodiments, gallium is added to the molten lithium bath such that the bath has a total gallium content of less than 20 atomic percent. In certain embodiments, indium is added to the molten lithium bath such that the bath has a total indium content of less than 20 atomic percent. In certain embodiments, zinc is added to the molten lithium bath such that the bath has a total zinc content of less than 30 atomic percent.

In other embodiments, an anode may be formed as a foil of a lithium alloy. The lithium alloy foil may be rolled or otherwise formed.

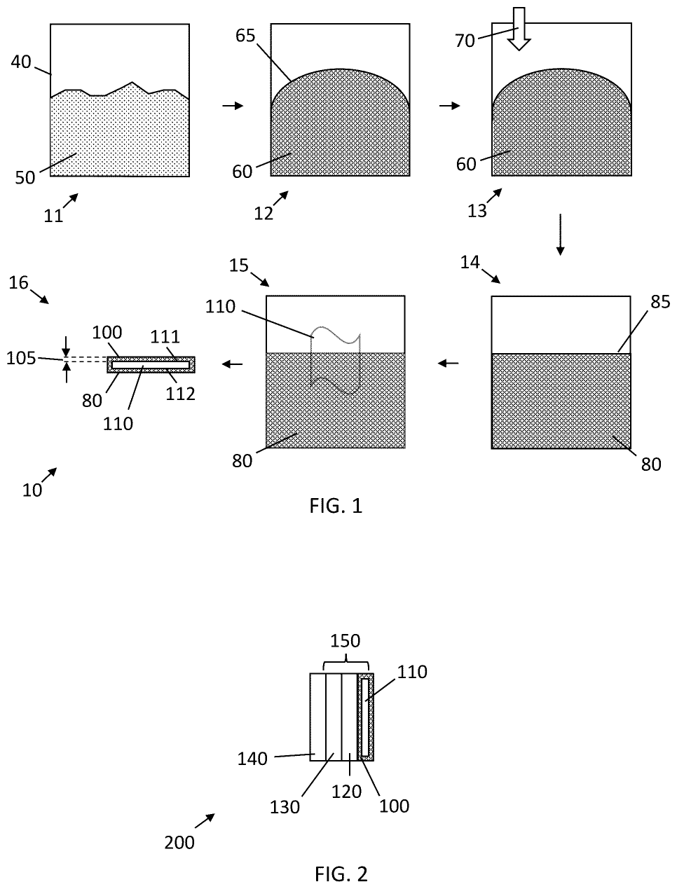

Referring to the drawings, wherein like reference numbers refer to like components, FIG. 1 is a simplified schematic representation of a method 10 for fabricating an anode 100 suitable for use in a battery for powering a vehicle, such as a purely electric vehicle or a hybrid electric vehicles. The vehicle may be any one of a number of different types of automobile, such as, for example, a sedan, a wagon, a truck or a sport utility vehicle (SUV).

As shown, the method 10 includes providing lithium 50, such as in a solid form like particulate or powder, in a vessel 40 at fabrication stage 11. The method further includes heating the vessel and lithium to melt the lithium to form molten lithium 60, i.e., a molten lithium bath 60, at fabrication stage 12. The molten lithium 60 has a high surface tension. Due to the high surface tension, the molten lithium bath 60 has an upper surface 65 that is round. Specifically, the upper surface 65 forms a convex meniscus, as shown. If provided in a larger vessel, the molten lithium bath 60 may form the shape of a ball. It has been determined that the high surface tension of the molten lithium bath 60 prevents wetting onto substrates such as copper or stainless steel substrates.

The method further includes adding a surface tension reduction agent or alloying element 70 to the molten lithium bath 60 to reduce the surface tension at fabrication stage 13. The surface tension reduction agent is selected from the group consisting of silver, tin, gallium, indium, zinc, and combinations thereof. Suitable surface tension reduction agents melt at the temperature of the bath, exhibit solubility in molten lithium, and form a binary liquid phase of lower free energy compared to pure lithium.

The addition of the surface tension reduction agent or alloying element 70 to the molten lithium bath 60 results in a melt 80 having reduced surface tension as compared to the molten lithium bath. In exemplary embodiments, the melt 80 may have an upper surface 85 that is planar or flat. In fact, the presence or absence of the meniscus may be used to control the amount of surface tension reduction agent 70 that is added to the molten lithium bath 60. In other words, when the flat upper surface 85 is formed, then sufficient surface tension reduction agent 70 has been added to the molten lithium bath 60. Thus, the method 10 may include ceasing the addition of the surface tension reduction agent or alloying element 70 to the bath when a sufficient amount has been added, as shown at fabrication stage 14.

In an exemplary embodiment, the surface tension reduction agent or alloying element 70 is silver and is added to the molten lithium bath 60 such that the melt 80 has a total silver content of less than 1 atomic percent, such as less than 0.9, 0.8, 0.7, 0.6, or 0.5 atomic percent. In an exemplary embodiment, the surface tension reduction agent or alloying element 70 is tin and is added to the molten lithium bath 60 such that the melt 80 has a total tin content of less than 10 atomic percent, such as less than 9, 8, 7, 6, 5, 4, 3, or 2 atomic percent. In an exemplary embodiment, the surface tension reduction agent or alloying element 70 is gallium and is added to the molten lithium bath 60 such that the melt 80 has a total gallium content of less than 20 atomic percent, such as less than 18, 16, 14, 12, 10, or 5 atomic percent. In an exemplary embodiment, the surface tension reduction agent or alloying element 70 is indium and is added to the molten lithium bath 60 such that the melt 80 has a total indium content of less than 20 atomic percent, such as less than 18, 16, 14, 12, 10, or 5 atomic percent. In an exemplary embodiment, the surface tension reduction agent or alloying element 70 is zinc and is added to the molten lithium bath 60 such that the melt 80 has a total zinc content of less than 30 atomic percent, such as less than 25, 20, 15, 12, 10, or 5 atomic percent. In an exemplary embodiment, the surface tension reduction agent or alloying element 70 is a combination of additives and is added to the molten lithium bath 60 such that the melt 80 has a total additive content of less than 40 atomic percent, such as less than 35, 32, 30, 25, 20, 15, 12, 10, or 5 atomic percent.

Thus, the method provides for forming a melt 80 including lithium and a surface tension reduction agent, wherein the surface tension reduction agent is selected from the group consisting of silver, tin, gallium, indium, zinc, and combinations thereof. After forming the melt 80 of lithium and the surface tension reduction agent, the method may continue with contacting an anode current collector 110 with the melt 80, as shown at fabrication stage 15. As a result, a layer of the melt 80 wets onto the anode current collector 110 to form the anode 100 as a lithium metal anode, and specifically as a lithium alloy metal anode. The improved wetting provided by the addition of the surface tension reduction agent improves adhesion of the lithium alloy active material to the current collector 110, resulting in better performance and longer lifetime of the anode and battery. In certain embodiments, the current collector 110 is formed from copper or stainless steel. In some embodiments, the current collector 110 may be formed from another suitable material.

In certain embodiments, the anode current collector 110 is immersed in the melt 80. For example, a portion of the anode current collector 110 may be immersed into the melt 80 as shown, or the entire anode current collector 110 may be immersed in the melt 80.

The method includes ceasing contact between the anode current collector 110 and the melt 80, such as shown at fabrication stage 16. For example, the anode current collector 110 may be removed from the bath and vessel. As shown, a layer of the melt 80 solidifies on the current collector 110 as the anode active material with a thickness of 105. The thickness is measured in a direction perpendicular to the surface of the current collector 110 (or to a tangent line of a curved surface of the current collector 110). In certain embodiments, the thickness 105 of the solid layer is at least 5 micrometers (μm), such as at least 10, 15, 20, 25, 30, 35, 40, 45, 50, or 55 micrometers (μm). In certain embodiments, the thickness 105 of the solid layer is no more than 80 micrometers (μm), such as no more than 75, 70, 65, 60, 55, 50, 45, 40, 35, 30 25, or 20 micrometers (μm).

As shown in FIG. 2, in certain embodiments, the method continues with fabricating a battery 200. For example, method may include wetting an anode current collector 110 with a melt 80 to form an anode 100 as a lithium alloy on the anode current collector 110. Also, the method may include separating the anode 100 from a cathode 130 with a separator 120. Further, the method may include contacting the anode 100 and the cathode 130 with an electrolyte 150.

FIGS. 1 and 2 illustrate the anode collector 110 as a foil or solid substrate, having two opposite surfaces 111 and 112. In FIG. 1, the lithium alloy is formed on both surfaces 111 and 112. It is contemplated that the lithium alloy may be formed only on one surface 111.

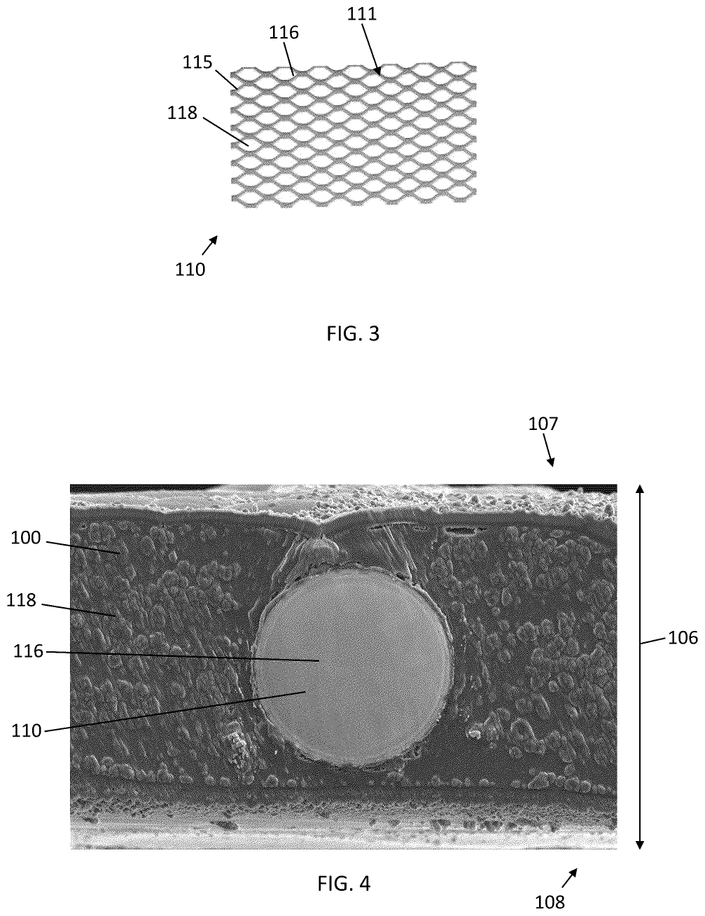

In certain embodiments, the anode collector 110 is a mesh or other porous substrate. For example, FIG. 3 provides a top view of an anode collector 110 formed as a mesh 115 of interconnected wires or ribbons 116 that define open cells 118. When a mesh anode collector 110 is contacted with the melt 80, the melt 80 surrounds the ribbons 116 and fills the open cells 118. Specifically, capillary forces may promote wicking of the melt 80 to spread across the anode collector 110, such as into the cells 118.

FIG. 4 illustrates a cross sectional view of a ribbon 116 and surrounding cells 118 of the mesh anode collector 110 after being contacted with the melt 80 to form the anode 100. As shown, the melt 80 fills the open cells 118 and surrounds the ribbons 116 such that the mesh is embedded in the anode 100. While the illustrated ribbon 116 has a circular cross-section, it is contemplated that the ribbons 116 may be formed with different shapes.

Further, the anode 100 has a maximum thickness 106 where the anode material extends continuously between opposite anode surfaces 107 and 108. In certain embodiments, the thickness 106 is at least 5 micrometers (μm), such as at least 10, 15, 20, 25, 30, 35, 40, 45, 50, or 55 micrometers (μm). In certain embodiments, the thickness 105 is no more than 80 micrometers (μm), such as no more than 75, 70, 65, 60, 55, 50, 45, 40, 35, 30 25, or 20 micrometers (μm).

Whether formed on a foil current collector 110 as in FIGS. 1 and 2 or on a mesh current collector 110 as in FIG. 4, the solid metal anode 100 is a lithium alloy (LiX), where X is the alloying element or elements 70. In certain embodiments, the lithium alloy has a lithium content of at least 70 atomic % lithium, such as at least 75, 78, 80, 81, 82, 83, 84, 85, 86, 87, 88, 89, 90, 91, 92, 93, 94, 95, 96, 97, 98, 99, 99.1, 99.2, 99.3, 99.4, 99.5, 99.6, 99.7, 99.8, or 99.9 atomic % lithium.

As described above, the surface tension reduction agent or alloying element 70 may be selected to reduce the surface tension of the bath before the current collector is contacted with the bath. Surface tension is the key parameter which determines wetting of a surface, such as the surface of the current collector. Surface tension (γ) is commonly defined as an unbalanced force (given in units dyn/cm or mN/m) which acts in a material to adapt the smallest possible surface under the set conditions. These unbalanced forces occur due to the cohesive forces between the molecules in the surface layer that are not evenly distributed to all sides compared to molecules in the inner phase.

When a molten liquid is contacted on the collector surface, surface tension forces come into play to redistribute the molten liquid. If the surface tension of a molten liquid is higher than that of the substrate, the molten liquid will obtain the lowest possible common surface with the substrate. Thus, the molten liquid will not wet the surface properly, leading to surface defects (bare spots on the current collector).

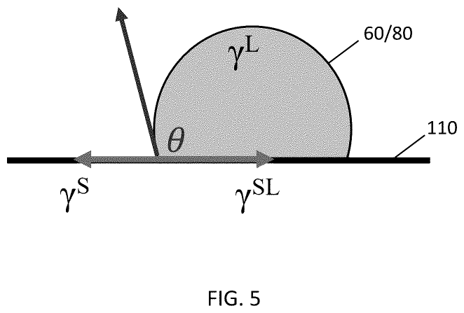

As shown in FIG. 5, the contact angle θ is the angle between the intersection of the liquid-solid interface and the liquid-vapor interface at the three-phase contact line. It is an indication of the ability of the liquid to spread on the substrate.

Solid/liquid (S/L) interfaces exhibit a different “surface tension” than the individual surfaces. The relationship between the S/L surface tensions can be derived from Young's Equation:

$$cos θ = \frac{{γ}^{s} - {γ}^{sL}}{{γ}^{L}}$$

where:
γ^{S} represents surface tension of solid (current collector);
γ^{L} represents surface tension of liquid (molten lithium or alloy);
γ^{SL} represents interfacial tension of solid/liquid; and
θ is the contact angle.

Thus, the interfacial tension γ^{SL} can be determined by measuring the contact angle θ. Partial wetting occurs if the contact angle θ is greater than zero and less than 90 degrees; spontaneous and complete wetting occurs when the contact angle θ is zero, implying γ^{S}>γ^{L} (surface tension of the solid is greater than surface tension of the liquid.

When the liquid is molten lithium 60, the surface tension γ^{L} is high and results in a high (obtuse) contact angle. Thus, a spherical ball formation of pure molten lithium may result. The surface tension γ^{L} of the molten liquid may be reduced by adding an alloying element (X) which reacts with lithium and replaces Li—Li bonds at the liquid surface with more Li—X bonds.

It has been determined that the alloying element should be selected such that: (a) the alloying element has solubility in lithium. Silver has particularly high solubility in lithium. Solubility may be indicated as the maximum equilibrium solubility limit, expressed in atomic percentage (at. %). A value of 100 at. % indicates complete solubility, while a value of 0 at. % indicates immiscibility. In practice, the solubility of silver in liquid lithium is from about 22 to about 35 at. % based on the temperature of the melted lithium. For example, the solubility of silver in lithium is 22 at. % when the temperature is 180° C., and is 35 at. % when the temperature is 300° C.

In certain embodiments, the solubility of the alloying element in the molten lithium at the process temperature may be at least 0.1 at. %, such as at least 0.5, 1, 2, 5, 10, 15, 20, 25, 30, or 35 at. %. In certain embodiments, the solubility of the alloying element in the molten lithium at the process temperature may be at most 40 at. %, such as at most 35, 30, 25, 20, 15, 10, 5, 2, 1, or 0.5 at. %.

Further, it has been determined that the alloying element X should be selected such that: (b) the Gibbs free energy of mixing is negative, i.e. the Li—X system has a much lower negative value of Gibbs free energy than Li—Li system at the same temperature.

A relationship between the contact angles and Gibbs free energy is seen in the following equation:

$$cos {θ}^{1} = cos {θ}^{0} - \frac{{Δγ}^{sL}}{{γ}^{L}} - \frac{Δ G}{{γ}^{L}}$$

where:
θ¹ is the contact angle of the molten Li—X alloy;
θ² is the contact angle of molten lithium; and
ΔG is the Gibbs free energy change resulting from adding alloying element X to the lithium.

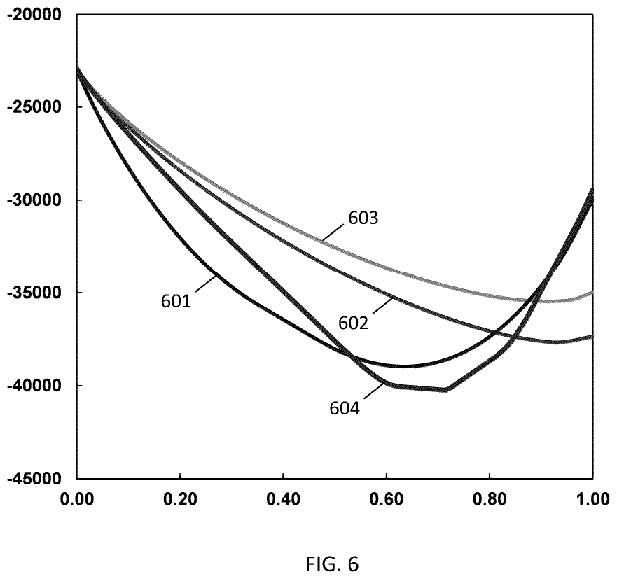

FIG. 6 is a free energy composition diagram for binary Li—X molten liquids as a function of the concentration of the alloying element X. In the diagram, the horizontal axis is the mole fraction of the alloying element X in the liquid, and the vertical axis is the change in Gibbs free energy of the binary mixture as compared to pure lithium (ΔGₘᵢₓ) in Joules.

Line 601 represents the change in free energy of a lithium-silver (Li—Ag) molten liquid. Line 602 represents the change in free energy of a lithium-tin (Li—Sn) molten liquid. Line 603 represents the change in free energy of a lithium-gallium (Li—Ga) molten liquid. Line 604 represents the change in free energy of a lithium-zinc (Li—Zn) molten liquid. A negative value of ΔGₘᵢₓ indicates spontaneous reaction between Li and the element X. As a result, new Li—X bonds replace the Li—Li bonds, improving the wettability of the melt.

It is noted that the thickness of the layer of lithium alloy (LiX) formed as the anode may increase as the absolute value of the change in free energy increases. Specifically, the wetting of the melt onto the current collector increases with increased alloying additions in the bath, leading to a greater amount of lithium alloy (LiX) formed on the current collector. Thus, methods herein may include tuning the alloying element additions to the bath to control the anode thickness. In certain embodiments, the process is controlled to form an anode having a thickness of at least 10 microns, such as at least 15, 20, 25, 30, 40, 50, 60, 70, 80, or 90 microns. In certain embodiments, the process is controlled to form an anode having a thickness of at most 100 microns, such as at most 95, 90, 85, 80, 70, 60, 50, 40, 30, 20, 15, or 12 microns. Generally, an anode formed on a wire mesh current collector may have a larger thickness.

As described herein, wettability of a lithium anode is improved by adding a selected element to form a binary molten liquid before contacting the liquid with the current collector. As a result, there is no need for an additional lithiophilic coating or surface treatment on the current collector to induce spontaneous wetting. Thus, an extra process step is avoided.

Also, adding the selected element to the molten lithium may prevent dissolution of copper, from a copper current collector, into the molten bath by chemical attack.

Accordingly, embodiments herein provide for improved wetting of current collectors with molten lithium anode material by adding a surface tension reduction agent in the form of an alloying element to the lithium. As a result, the current collected need not be coated or surface treated before contact with the anode material melt. When the anode material melt and current collector are contacted, the molten alloy wets and forms a layer on the current collector. In this manner, the lithium-containing anode is formed efficiently on the current collector. Embodiments herein provide for controlled addition of specific alloying elements (Ag, Ga, In, Zn) to molten lithium. This is a cost effective method to modify the surface tension of molten lithium and avoids an additional step of pretreating the current collector surface to provide a lithiophilic coating.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing summary and detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for fabricating an anode, the method comprising:
forming a melt comprising lithium and a surface tension reduction agent, wherein the surface tension reduction agent is selected from the group consisting of silver, tin, gallium, indium, zinc, and combinations thereof; and
contacting an anode current collector with the melt, wherein a layer of the melt wets onto the anode current collector to form the anode as a lithium alloy.

2. The method of claim 1, wherein the layer of the melt has a thickness of from 30 to 60 micrometers (μm).

3. The method of claim 1, wherein the anode current collector is formed as a mesh of ribbons, and wherein the layer of the melt surrounds the ribbons.

4. The method of claim 1, wherein forming the melt comprises:
melting solid lithium to form molten lithium; and
adding the surface tension reduction agent to the molten lithium.

5. The method of claim 1, wherein forming the melt comprises:
melting solid lithium to form molten lithium having a round surface; and
adding the surface tension reduction agent to the molten lithium to form the melt.

6. The method of claim 1, wherein forming the melt comprises:
melting solid lithium to form molten lithium having a round surface; and
adding the surface tension reduction agent to the molten lithium until the melt has a flat surface.

7. The method of claim 1, wherein the surface tension reduction agent is silver, and wherein the lithium alloy is a lithium-silver alloy comprising less than 1 atomic % silver.

8. The method of claim 1, wherein the surface tension reduction agent is tin, and wherein the lithium alloy is a lithium-tin alloy comprising less than 10 atomic % tin.

9. The method of claim 1, wherein the surface tension reduction agent is gallium, and wherein the lithium alloy is a lithium-gallium alloy comprising less than 20 atomic % gallium.

10. The method of claim 1, wherein the surface tension reduction agent is indium, and wherein the lithium alloy is a lithium-indium alloy comprising less than 20 atomic % indium.

11. The method of claim 1, wherein the surface tension reduction agent is zinc, and wherein the lithium alloy is a lithium-zinc alloy comprising less than 30 atomic % zinc.

12. A method for fabricating a battery, the method comprising:
wetting an anode current collector with a melt to form an anode as a lithium alloy on the anode current collector, wherein the melt comprises lithium and a surface tension reduction agent, and wherein the surface tension reduction agent is selected from the group consisting of silver, tin, gallium, indium, zinc, and combinations thereof;
separating the anode from a cathode with a separator; and
contacting the anode and the cathode with an electrolyte.

13. The method of claim 12, further comprising forming the melt by melting solid lithium to form molten lithium and adding the surface tension reduction agent to the molten lithium.

14. The method of claim 12, further comprising forming the melt by melting solid lithium to form molten lithium having a round surface and adding the surface tension reduction agent to the molten lithium until the melt has a flat surface.

15. A lithium battery comprising:
an anode current collector formed from a collector material;
an anode active material directly contacting the collector material, wherein the anode active material is a lithium alloy of lithium and silver, tin, gallium, indium, and/or zinc;
a cathode active material;
a separator between the anode active material and the cathode active material; and
an electrolyte in contact with the anode active material and the cathode active material.

16. The lithium battery of claim 15, wherein the lithium alloy is a lithium-silver alloy comprising less than 1 atomic % silver.

17. The lithium battery of claim 15, wherein the lithium alloy is a lithium-tin alloy comprising less than 10 atomic % tin.

18. The lithium battery of claim 15, wherein the lithium alloy is a lithium-gallium alloy comprising less than 20 atomic % gallium.

19. The lithium battery of claim 15, wherein the lithium alloy is a lithium-zinc alloy comprising less than 30 atomic % zinc.

20. The lithium battery of claim 15, wherein the anode current collector is a mesh formed by ribbons of the collector material, and wherein the mesh is surrounded by the anode active material.
